(19) United States
(12) Patent Application Publication
(10) Pub. No.: US 2007/0139704 A1
(43) Pub. Date: Jun. 21, 2007

(54) IMAGE COMMUNICATION APPARATUS AND IMAGE COMMUNICATION METHOD

(75) Inventor: Keigo Ogura, Tokyo (JP)

Correspondence Address: CANON U.S.A. INC. INTELLECTUAL PROPERTY DIVISION, 15975 ALTON PARKWAY, IRVINE, CA, 92618-3731, US

(73) Assignee: CANON KABUSHIKI KAISHA, Tokyo (JP)

(21) Appl. No.: 11/609,681

(22) Filed: Dec. 12, 2006

(30) Foreign Application Priority Data
Dec. 20, 2005 (JP) 2005-366560

(51) Int. Cl. G06F 3/12

(52) U.S. Cl. 358/1.15; 358/402

(57) ABSTRACT

An image communication apparatus and method for controlling the image communication apparatus includes a receiving first data from an external device, storing the first data when the first data includes specific information, reading a document image and creating document image data, creating second data by adding the document image data to the first data, determining a transmission destination of the second data based on the first data, and transmitting the second data to the determined transmission destination.

### BACKGROUND OF THE INVENTION

1. Field of the Invention

The present invention relates to an image communication apparatus configured to combine image data with a received electronic mail and transmit a composed mail to a destination.

2. Description of the Related Art

The multifunction peripheral (hereinafter, referred to as “MFP”) has a copy function, a print function, a scan function (i.e., image read function), and a facsimile/network transmission/reception function. The MFP can read (scan) image data of an original document and can transmit an electronic mail including the scanned image data to a desired destination designated by an electronic mail address (refer to Japanese Patent Application Laid-open No. 2004-336562).

Furthermore, the MFP includes an operation screen that enables a user to input a text (i.e., character string) of an electronic mail including attached image data. The MFP operation screen is a large-scale touch panel that can improve the operability.

However, the MFP operation screen is not efficient to input a long sentence forming a text of an electronic mail because it takes a long time for a user. The MFP may be occupied by only one user, and other users may wait for a long time until they can use the MFP. The situation that the same user occupies an MFP for a long time is not preferable.

Meanwhile, transmitting an electronic mail including attached image data, where the original of the attached image data is a hardcopy, via a personal computer (PC) requires complicated operations. More specifically, a user is required to create a mail text using application software on a personal computer, and is required to scan the original document using an MFP. Then, the user is required to combine the scanned image data with an electronic mail and transmit the electronic mail to a destination.

### SUMMARY OF THE INVENTION

Exemplary embodiments of the present invention are directed to an image communication apparatus that can improve the operability in the processing for transmitting, to a destination, an electronic mail including attached image data of a paper document scanned by an scanning device.

According to an aspect of the present invention, an image communication apparatus includes a reception unit configured to receive first data from an external device, a storage unit configured to store the first data when the first data includes specific information, a reading unit configured to read a document image and create document image data, an addition unit configured to create second data by adding the document image data to the first data, a determination unit configured to determine a transmission destination of the second data based on the first data, and a transmission unit configured to transmit the second data to the transmission destination.

According to another aspect of the present invention, a method for controlling an image communication apparatus includes receiving first data from an external device, storing the received first data when the first data includes specific information, reading a document image and creating document image data, creating second data by adding the document image data to the first data, determining a transmission destination of the second data based on the first data, and transmitting the second data to the determined transmission destination.

According to yet another aspect of the present invention, a computer-readable storage medium stores computer-executable process steps that enables a computer to execute the image communication method.

According to exemplary embodiments of the present invention, the image data of a paper document scanned by an MFP can be attached to an electronic mail created by a personal computer (PC) and can be transmitted to a destination. Thus, a user is not required to create a text of an electronic mail when the user attaches a file of image data using a scan function of the MFP. Thus, the exemplary embodiments of the present invention can improve the operability of the image communication system.

Further features and aspects of the present invention will become apparent from the following detailed description of exemplary embodiments with reference to the attached drawings.

### BRIEF DESCRIPTION OF THE DRAWINGS

The accompanying drawings, which are incorporated in and constitute a part of the specification, illustrate exemplary embodiments, features, and aspects of the invention and, together with the description, serve to explain the principles of the invention.

FIG. 1 is a block diagram illustrating an overall system arrangement in accordance with an exemplary embodiment of the present invention.

FIG. 2 is a block diagram illustrating a copy action of an MFP.

FIG. 3 is a block diagram illustrating a storage action of an MFP including an image storage section that can store a scan image.

FIG. 4 is a block diagram illustrating a printout action of the MFP that can print the image stored in the image storage section.

FIG. 5 is a block diagram illustrating a sending action of the MFP that can send the scan image.

FIG. 6 is a block diagram illustrating a sending action of the MFP that can send the image stored in the image storage section.

FIG. 7 is a block diagram illustrating functional blocks of an image processing section in the MFP.

FIG. 8 is a block diagram illustrating functional blocks of a compression/expansion processing section in the MFP.

FIG. 9 illustrates an example of an operating section of the MFP.

FIG. 10 is a flowchart illustrating integration processing according to an exemplary embodiment of the present invention.

FIG. 11 is a flowchart illustrating details of the processing shown in FIG. 10.

FIG. 12 illustrates an operation screen used in a fourth exemplary embodiment of the present invention.

FIG. 13 illustrates an operation screen used in the fourth exemplary embodiment.

FIG. 14 illustrates an operation screen used in a first exemplary operation.

FIG. 15 illustrates an operation screen used in the first exemplary operation.

FIG. 16 illustrates an operation screen used in the first exemplary operation.

FIG. 17 illustrates an operation screen used in a second exemplary operation.

FIG. 18 illustrates an operation screen used in the second exemplary operation.

FIG. 19 illustrates an operation screen used in the second exemplary operation.

FIG. 20 illustrates an electronic mail transmission action performed via the MFP according to the third exemplary embodiment.

FIG. 21 illustrates an example of an electronic mail created by a PC.

FIG. 22 illustrates an example of an electronic mail created by the MFP.

FIG. 23 illustrates another example of the electronic mail created by the MFP.

FIG. 24 is a flowchart illustrating electronic mail reception processing performed by the MFP according to the exemplary embodiment.

FIG. 25 illustrates an example of the operating section of the MFP that can display a temporary box.

FIG. 26 is a flowchart illustrating electronic mail transmission processing performed by the MFP that can transmit an electronic mail stored in the temporary box according to the exemplary embodiment.

### DETAILED DESCRIPTION OF THE EMBODIMENTS

The following description of exemplary embodiments is merely illustrative in nature and is in no way intended to limit the invention, its application, or uses.

Processes, techniques, devices, and systems as known by one of ordinary skill in the art may not be discussed in detail but are intended to be part of the enabling description where appropriate.

For example, certain circuitry for image processing, data processing, and other uses may not be discussed in detail. However these systems and the methods to fabricate these system as known by one of ordinary skill in the relevant art is intended to be part of the enabling disclosure herein where appropriate.

It is noted that throughout the specification, similar reference numerals and letters refer to similar items in the following figures, and thus once an item is defined in one figure, it may not be discussed for following figures.

Exemplary embodiments will be described in detail below with reference to the drawings.

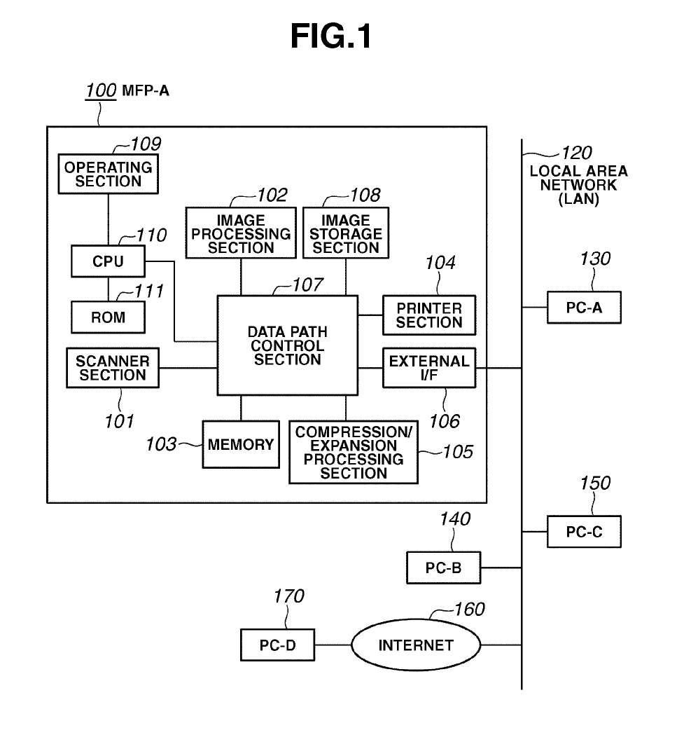

FIG. 1 is a block diagram illustrating an overall system arrangement in accordance with an exemplary embodiment of the present invention. [0046] A local area network (LAN) 120 is connected to an MFP-A 100, a PC-A 130, a PC-B 140, and a PC-C 150. The LAN 120 is connected to the Internet 160. A PC-D 170 is connected to the Internet.

Each of the PC-A 130, PC-B 140, and PC-C 150 connected to the LAN 120, and the PC-D 170 connected to the Internet 160 are information processing apparatuses (e.g., personal computers). The information processing apparatuses (PCs) can transmit and receive various data including print data and electronic mails to and from the MFP-A 100 or other PCs. Furthermore, the information processing apparatuses (PCs) can control the MFP-A 100.

The PC-D 170 is connected to the LAN 120 via the Internet 160. If necessary, the PC-D 170 can transmit and receive data and electronic mail to or from other PCs connected to the LAN 120.

The MFP-A 100 is a multifunction peripheral (MFP) capable of functioning as an image communication apparatus or an image processing apparatus that has various functions (e.g., copy, facsimile transmission/reception, network transmission/reception, print, scan image reading).

In the MFP-A 100, a scanner section 101 is equipped with a charge-coupled device (CCD) that can optically read (scan) a document. The scanner section 101 can perform analog/digital conversion processing to produce RGB (red, green, and blue) digital signals representing the captured image.

An image processing section 102 can input the digitized RGB signals from the scanner section 101. The image processing section 102 can perform various image processing including filtering, color conversion, and size change, and can output signals formatted according to each output destination. For example, the image processing section 102 can produce CMYK (cyan, magenta, yellow, and black) binary image signals to a color binary printer. The image processing section 102 can execute various image processing and produce RGB multi-value signals for a color multi-value printer.

A memory 103, e.g., a random access memory (RAM) or other storage medium, can store various image data, such as RGB image data sent from the scanner section 101 and image data produced from the image processing section 102. The memory 103 enables the MFP-A 100 to print the same image data a plurality of times by repeatedly reading the information stored in the memory 103 without scanning a document. Thus, using the memory 103 is effective in reducing the print processing time.

A printer section 104 can perform printout processing based on the image data. In the present exemplary embodiment, the printer section 104 is a color binary printer that can use four-color (CMYK) inks. However, the printer section 104 can be any other type of printer, such as a color printer capable of outputting color multi-value signals or a monochrome printer. The print system can be an electrophotographic system or an inkjet recording system.

A compression/expansion processing section 105 can perform processing for compressing and expanding RGB multi-value image data or CMYK binary image data. An image storage section 108 can store a plurality of image data. The image storage section 108 can use a hard disk drive (HDD) or other large-scale storage medium capable of storing a large amount of data. A central processing unit (CPU) 110 of the MFP-A 100 can manage the data stored in the image storage section 108. The image storage section 108 can form a later-described “box.” The image data read (scanned) by the scanner section 101 can be stored in the box. Furthermore, image data, print data, and document data received from external devices via the LAN 120 can be stored in the box. The various types of data (i.e., image data, print data, and document data) stored in the box are referred to as a “box document.”

An external interface (hereinafter, referred to as “external I/F”) 106 enables the MFP-A 100 to input and output various image data and control commands via the LAN 120 to perform communications according to various network protocols. A data path control section 107 can perform transmission/reception of image data to and from various processing sections according to an action of the MFP-A 100. CPU 110, in addition to managing the data stored in the image storage section, can control various processing sections (e.g., data path control section 107) in various action modes according to an instruction entered by a user from an operating section 109. The CPU 110 can execute programs stored in a ROM 111 to control the MFP-100. The CPU 110 can load the programs from the ROM 111 into the memory 103 and execute the programs.

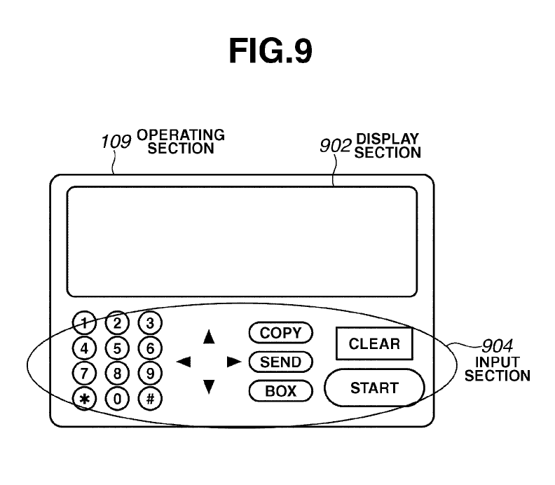

The operating section 109 according to the present embodiment, as illustrated in FIG. 9, includes a display section 902 (e.g., a touch panel liquid crystal display). Furthermore, an input section 904 includes keys enabling a user to input numerical data, cursor shift keys enabling a user to shift a cursor displayed on the display section 902, mode setting keys, a start key, and a clear key. A “copy” mode key, a “send” mode key, and a “box” mode key can function as mode setting keys that enable a user to switch the action mode of the MFP-A 100. The “start” key enables a user to instruct start of the action. The “clear” key enables a user to clear the settings. A user of the MFP-A 100 can operate the input section 904 of the operating section 109 or the touch panel of the display section 902 while watching a screen of the display section 902 to realize a desired operation of the MFP-A 100.

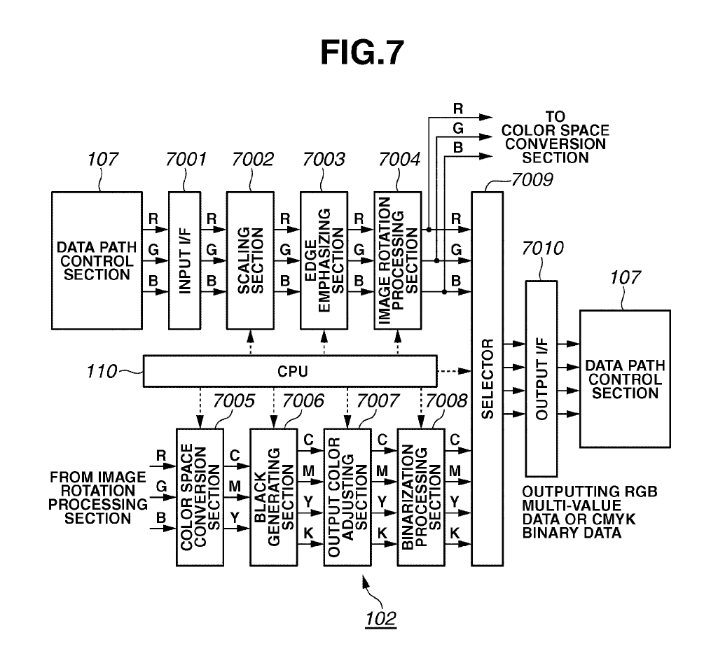

Next, the image processing section 102 in the MFP-A 100 will be described below in detail. FIG. 7 is a block diagram illustrating functional blocks of the image processing section 102. The image processing section 102 can convert the RGB multi-value image data entered from the scanner section 101 into CMYK binary image data so that the printer section 104 can perform a print output operation.

An input interface 7001 can receive image data entered from the data path control section 107, and can perform conversion of data according to the internal processing of the image processing section 102. In the present embodiment, the input interface 7001 performs input of RGB multi-value image data.

A scaling section 7002 can perform enlargement/reduction processing by applying a resolution conversion to the RGB multi-value image data entered from the input interface 7001 according to the resolution of a printer and the paper size.

An edge emphasizing section 7003 can perform sharpness processing and smoothing processing by performing weighted calculations in n×m areas.

An image rotation processing section 7004 can temporarily store the image data in a built-in memory and can perform image rotation processing (e.g., 90-degree rotation) to, for example, convert the layout of image data from the portrait position to the landscape position according to an output paper.

A color space conversion section 7005 can convert a color space of the entered image data into another color space if necessary. In the present embodiment, the color space conversion section 7005 performs logarithm (LOG) conversion for converting the RGB image data entered from the scanner section 101 into image data in a CMY color space used in the print output operation of the printer section 104.

A black generating section 7006 can extract a lowest value of CMY signals as a K signal value.

An output color adjusting section 7007 can adjust the tint and the concentration of CMYK values according to printer characteristics.

A binarization processing section 7008 can perform binary conversion processing using pseudo-halftone processing (e.g., an error diffusion method) to output 1-bit CMYK binary signals which are sent to a color binary printer.

A selector 7009 can select the RGB multi-value image data or the CMYK binary image data and output the selected image data.

An output interface 7010 can perform conversion of the data to the format required when the image data signals selected by the selector 7009 are output to the data path control section 107. In the present embodiment, the output interface 7010 outputs the CMYK binary image data.

The settings and operations of the above-described processing sections can be controlled based on control signals supplied from the CPU 110. For example, settings of a variable copy ratio in the scaling section 7002, filtering coefficients in the edge emphasizing section 7003, the necessity of rotation and a required rotational angle in the image rotation processing section 7004, and the processing method in the binarization processing section 7008 can be controlled based on control signals supplied from the CPU 110.

Next, the compression/expansion processing section 105 in the MFP-A 100 will be described below.

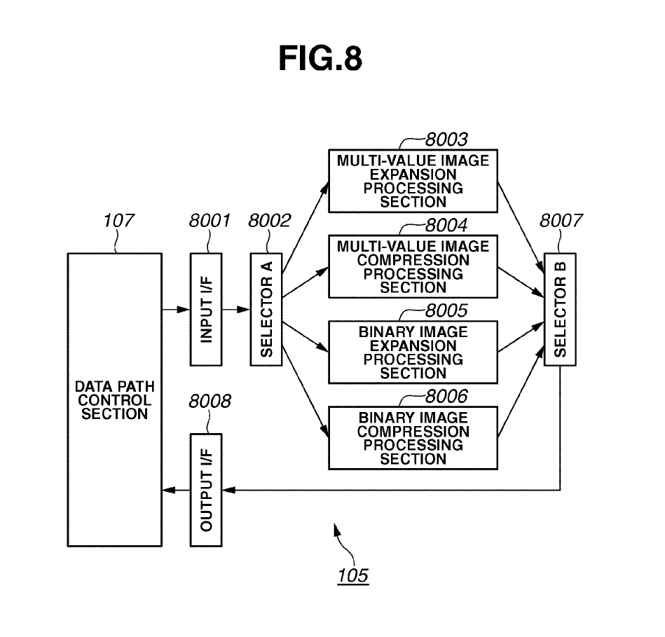

FIG. 8 is a block diagram illustrating functional blocks of the compression/expansion processing section 105.

An input interface (I/F) 8001 can input image data from the data path control section 107.

A selector-A 8002 can send the entered image data to a multi-value image expansion processing section 8003 when the entered image data is compressed multi-value image data. The selector-A 8002 can send the entered image data to a multi-value image compression processing section 8004 when the entered image data is non-compressed multi-value image data. The selector-A 8002 can send the entered image data to a binary image expansion processing section 8005 when the entered image data is compressed binary image data. Furthermore, the selector-A 8002 can send the entered image data to a binary image compression processing section 8006 when the entered image data is non-compressed data.

The multi-value image expansion processing section 8003 can expand the multi-value image data compressed through the data compression processing. In the present embodiment, the multi-value image expansion processing section 8003 performs the Joint Photographic Coding Experts Group (JPEG) expansion processing.

The multi-value image compression processing section 8004 can compress the non-compressed RGB multi-value image data entered from the scanner section 101. In the present embodiment, the multi-value image compression processing section 8004 performs the JPEG compression processing.

The binary image expansion processing section 8005 can expand the binary image data compressed through the data compression processing. In the present embodiment, the binary image expansion processing section 8005 performs the Joint Bi-level Image experts Group (JBIG) expansion processing.

The binary image compression processing section 8006 can compress the non-compressed CMYK binary image data, such as the printout data entered from the image processing section 102. In the present embodiment, the binary image compression processing section 8006 performs the JBIG compression processing.

The present embodiment uses the JPEG system for compressing multi-value images and the JBIG system for compressing binary images. However, the present embodiment is not limited to using the JPEG system, and can use any other compression system that would enable practice of the present invention.

A selector-B 8007 can select an output signal of the multi-value image expansion processing section 8003 when the image data entered from the input I/F 8001 is compressed multi-value image data. The selector-B 8007 can select an output signal of the multi-value image compression processing section 8004 when the image data entered from the input I/F 8001 is non-compressed multi-value image data. The selector-B 8007 can select an output signal of the binary image expansion processing section 8005 when the image data entered from the input I/F 8001 is compressed binary image data. Furthermore, the selector-B 8007 can select an output signal of the binary image compression processing section 8006 when the image data entered from the input I/F 8001 is non-compressed binary image data. An output interface (I/F) 8008 can output the image data processed in the compression/expansion processing section 105 to the data path control section 107.

Next, various actions of the MFP-A 100 and the flow of data in the MFP-A 100 will be described below.

<Copy Action>

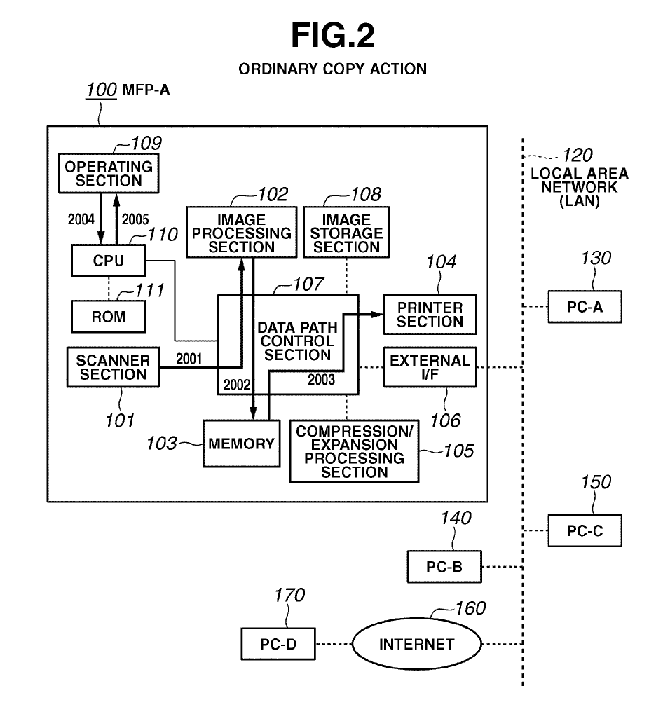

FIG. 2 illustrates the flow of image data in the MFP-A 100 that can perform a copy action according to the present embodiment. The components or portions similar to those illustrated in FIG. 1 are denoted by the same reference numerals.

A user can operate the operating section 109 to perform settings of a copy mode, including the number of copies and the type of document. After accomplishing various settings of the copy mode, the user can instruct start of a copy action through the input section 904 of the operating section 109.

The scanner section 101 scans (i.e., executes a document reading action) and outputs RGB document image data. The image processing section 102 inputs the document image data and executes predetermined image processing according to the settings entered through the operating section 109. In the present embodiment, the image processing section 102 converts the entered RGB image data into CMYK binary image data (i.e., print output data). The flow of image data transferred in the above processing is indicated by a data path 2001 in FIG. 2.

The image processing section 102 performs various image processing and outputs CMYK binary print image data to the data path control section 107. The memory 103 stores the CMYK binary data. The flow of image data transferred in the above processing is indicated by a data path 2002 in FIG. 2.

After the document image data is stored in the memory 103, the CMYK binary data are read out of the memory 103 and sent, via the data path control section 107, to the printer section 104 that performs printout processing. The flow of data in this processing is indicated by a data path 2003 in FIG. 2.

If a plurality of copies is required, image data stored in the memory 103 can be used again in any succeeding printout operations. Therefore, the document scanning operation can be omitted. When the printout operation of a requested number of copies is finished, the MFP-A 100 terminates the copy action.

A user can input settings relating to the “copy” action through the operating section 109. The CPU 110 can input “copy” action settings. Each processing section of the MFP-A 100 performs a designated action under the control of CPU 110. The CPU 110 sends data to the operating section 109 for a screen display enabling a user to perform settings and a display of an operation state of the MFP-A 100 that executes the “copy” action. A user can confirm the data displayed on the display section 902. The transmission/reception of the data in the settings is indicated by two data paths 2004 and 2005 in FIG. 2.

<Scan to Box Action>

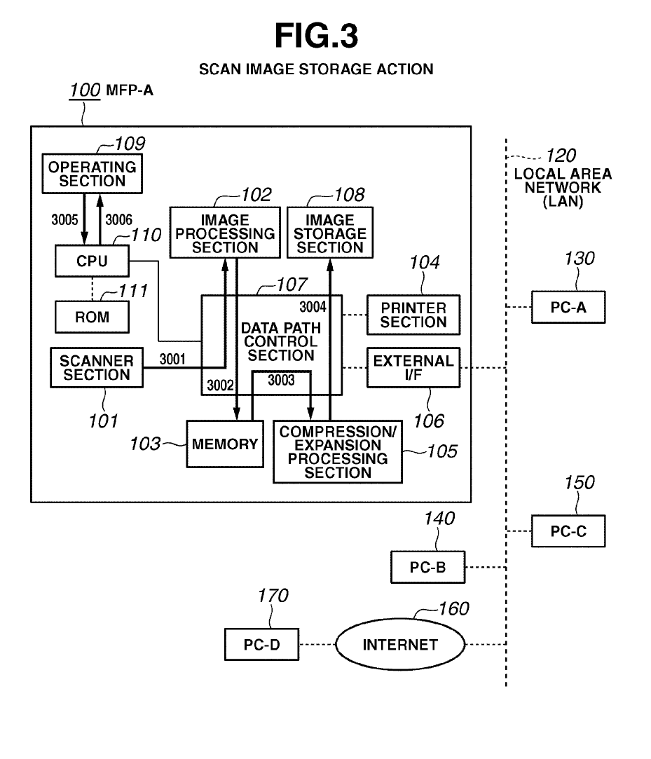

FIG. 3 illustrates the flow of image data in the MFP-A 100 that can compress the document image data read by the scanner section 101 and store the compressed image data in the image storage section 108 in the MFP-A 100. The action illustrated in FIG. 3 is referred to as a “scan to box” action. Furthermore, the function of storing the image data into the image storage section 108 from the scanner section 101 or from an external device, the function of printing the image data stored in the image storage section 108, and the function of facsimile transmitting or network transmitting the image data are referred to as box functions. In FIG. 3, the components or portions similar to those illustrated in FIG. 1 are denoted by the same reference numerals.

A user can perform various settings (e.g., document size and type, reading resolution, and selection of folder in the image storage section) through the operating section 109 for an image reading operation. After finishing various settings, the user can select a scan start key provided in the input section 904.

The scanner section 101 scans (i.e., executes a document read action) to output RGB document image data. The image processing section 102 inputs the document image data and executes predetermined image processing according to the settings. In the present embodiment, the image processing section 102 converts the entered RGB image data into RGB multi-value image data storable in the image storage section 108. The flow of image data in the processing is indicated by a data path 3001 in FIG. 3.

The image processing section 102 performs various image processing and outputs RGB multi-value image data storable in the image storage section 108 to the data path control section 107. The memory 103 stores the RGB multi-value data. The flow of image data transferred in the above processing is indicated by a data path 3002 in FIG. 3.

After the document image data is entirely stored in the memory 103, the RGB multi-value data is readout of the memory 103 and sent to the compression/expansion processing section 105 via the data path control section 107. The flow of data in the above transfer processing is indicated by a data path 3003 in FIG. 3.

The compression/expansion processing section 105 performs the JPEG compression processing for the entered RGB multi-value image data (i.e., non-compressed image data). After accomplishing the JPEG compression processing, the compression/expansion processing section 105 sends the RGB multi-value JPEG image data to the image storage section 108 via the data path control section 107. The image storage section 108 stores the JPEG image data in a designated folder. The flow of image data transferred in the above processing is indicated by a data path 3004 in FIG. 3.

A user can input settings relating to the “scan to box” action through the operating section 109. The CPU 110 can input “scan to box” settings. Each processing section of the MFP-A 100 performs a designated action under the control of CPU 110. The CPU 110 sends data to the operating section 109 for a screen display enabling a user to perform settings and a display of an operation state of the MFP-A 100 that executes the “scan to box” action. A user can confirm the data displayed on the display section 902. The transmission/reception of the data in the settings is indicated by two data paths 3005 and 3006 in FIG. 3.

<Box Print>

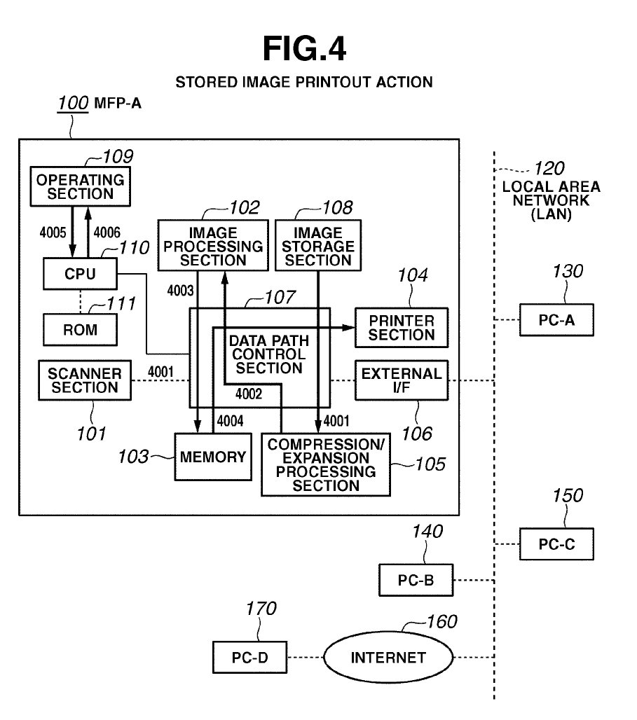

FIG. 4 illustrates the flow of image data in the MFP-A 100 that can print the image data stored in the image storage section 108. The action shown in FIG. 4 is referred to as a “box print” action. In FIG. 4, the components or portions similar to those illustrated in FIG. 1 are denoted by the same reference numerals.

A user can perform various settings through the operating section 109 of the MFP-A 100 for designation of a folder in the image storage section 108 that stores the image data to be printed, and designation of an image to be printed, as well as settings of various printout modes (e.g., print copy number, one-sided/two-sided print, and finishing settings). After finishing various settings, the user can select a print start key provided in the input section 904.

In response to a print start instruction, the image storage section 108 sends the designated image data (i.e., JPEG compressed RGB data) to the compression/expansion section 105 via the data path control section 107. The flow of image data transferred in the above processing is indicated by a data path 4001 in FIG. 4.

The compression/expansion section 105 performs the JPEG expansion processing for the RGB multi-value image data (i.e., JPEG compressed image data). The compression/expansion section 105 sends the RGB multi-value image data (i.e., the image data having been subjected to the JPEG expansion processing) to the image processing section 102 via the data path control section 107. The flow of image data transferred in the above processing is indicated by a data path 4002 in FIG. 4.

The image processing section 102 performs various image processing for the entered RGB multi-value image data, and sends CMYK binary print image data (i.e., processed image data) to the data path control section 107. The memory 103 stores the CMYK binary data. The flow of image data transferred in the above processing is indicated by a data path 4003 in FIG. 4.

The memory 103 sends the stored CMYK binary data via the data path control section 107 to the printer section 104 that can perform a printout operation. The flow of image data transferred in the above processing is indicated by a data path 4004 in FIG. 4.

If a plurality of print products is required, image data stored in the memory 103 can be used again in succeeding printout operations. Therefore, it is unnecessary to read the image data from the image storage section 108 and perform image processing for the succeeding printout operations. When the printout operation of a requested number of prints is finished, the MFP-A 100 terminates the print action.

A user can input settings relating to the “box print” action through the operating section 109. The CPU 110 can input “box print” settings. Each processing section of the MFP-A 100 performs a designated action under the control of CPU 110. The CPU 110 sends data to the operating section 109 for a screen display enabling a user to perform settings and a display of an operation state of the MFP-A 100 that executes the “box print” action. A user can confirm the data displayed on the display section 902. The transmission/reception of the data in the settings is indicated by two data paths 4005 and 4006 in FIG. 4.

<Sending Action>

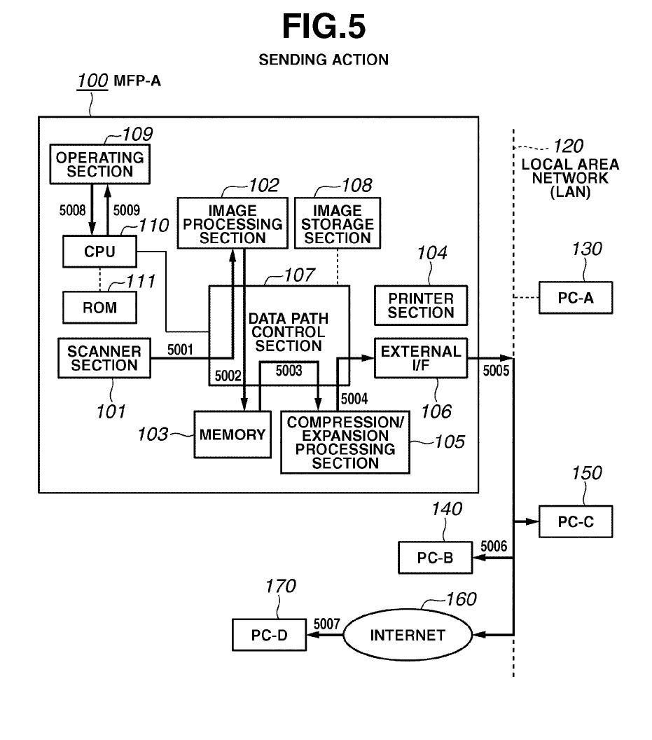

FIG. 5 illustrates the flow of image data in the MFP-A 100 that can read image data from the scanner section 101, compress the image data, create an electronic mail including an attached file of compressed image data, and transmit the electronic mail via a network to other image processing apparatus or PC. The action illustrated in FIG. 5 is referred to as a “send” action. In FIG. 5, the components or portions similar to those illustrated in FIG. 1 are denoted by the same reference numerals.

A user can perform various settings through the operating section 109 of the MFP-A 100 for setting an address of a transmission destination and designating processing of the image data in the transmission (e.g., resolution, and image file format). After finishing various settings, the user can select an execution start key provided in the operating section 109. In the present embodiment, the transmission destination can be the PC-B 140 or the PC-C 150 connected to the LAN 120, or the PC-D 170 connected to the Internet 160, or an MFP (not shown) connected to the LAN 120 or the Internet 160.

The scanner section 101 scans (i.e., performs a document reading action) and sends the RGB document image data to image processing section 102. The image processing section 102 inputs the document image data and executes predetermined image processing according to a user's settings. In the present embodiment, the image processing section 102 converts the entered RGB image data into RGB multi-value image data attachable to an electronic mail. The flow of image data transferred in the above processing is indicated by a data path 5001 in FIG. 5.

The image processing section 102 performs various image processing and sends RGB multi-value image data attachable to an electronic mail, via the data path control section 107, to the memory 103. The memory 103 stores the RGB multi-value data. The flow of image data transferred in the above processing is indicated by a data path 5002 in FIG. 5.

After the document image data is stored in the memory 103, the memory 103 sends the RGB multi-value data via the data path control section 107 to the compression/expansion processing section 105. The flow of image data transferred in the above processing is indicated by a data path 5003 in FIG. 5.

The compression/expansion processing section 105 perform the JPEG compression processing for the entered RGB multi-value image data (i.e., non-compressed image data). The compression/expansion processing section 105 sends, as image data to be attached to an electronic mail, the RGB multi-value JPEG image data (i.e., the image data having been subjected to the JPEG compression processing) to the external I/F 106 via the data path control section 107. The flow of data in the above transfer processing is indicated by a data path 5004 in FIG. 5.

The external I/F 106 performs processing for attaching the entered RGB multi-value JPEG image data, as an attached file, to an electronic mail created beforehand according to the settings entered from the operating section 109, and outputs the electronic mail to the LAN 120. The flow of data in the above transfer processing is indicated by a data path 5005 in FIG. 5.

Similar to an ordinary electronic mail, the electronic mail including an attached file can be sent from the external I/F 106 of the MFP-A 100 to a transmission destination (e.g., PC-B 140, PC-C 150, or the like connected to the LAN 120). The flow of electronic mail is indicated by a data path 5006 in FIG. 5. Furthermore, the electronic mail including an attached file can be sent to the PC-D 170 via the Internet 160 if the PC-D 170 is designated as a transmission destination. The flow of electronic mail in this case is indicated by a data path 5007 in FIG. 5. In the ordinary electronic mail transmission, the data paths 5006 and 5007 can include a Simple Mail Transfer Protocol (SMTP) server and a Post Office Protocol (POP) server, although not illustrated in FIG. 5.

A user can perform settings relating to the “send” action through the operating section 109. The CPU 110 can input “send” settings. Each processing section of the MFP-A 100 performs a designated action under the control of CPU 110. The CPU 110 sends data to the operating section 109 for a screen display enabling a user to perform settings and a display of an operation state of the MFP-A 100 that executes the “send” action. A user can confirm the data displayed on the display section 902. The transmission/reception of the data in the settings is indicated by two data paths 5008 and 5009 in FIG. 5.

<Box to Send>

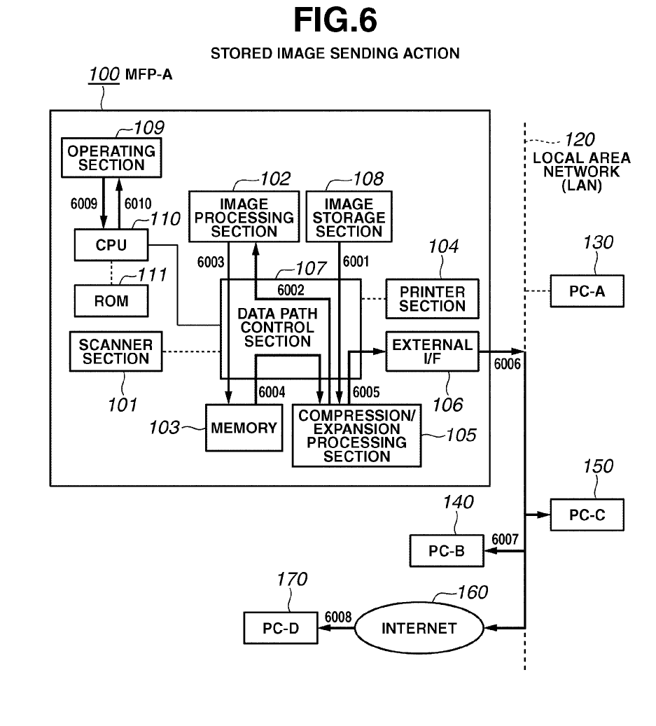

FIG. 6 illustrates the flow of image data in the MFP-A 100 that can perform image processing for the image data stored in the image storage section 108, create an electronic mail including the processed image data as an attached file, and transmit the electronic mail. The action shown in FIG. 6 is referred to as a “box to send” action. In FIG. 6, the components or portions similar to those illustrated in FIG. 1 are denoted by the same reference numerals.

A user can designate, through operations on the operating section 109, a box in the image storage section 108 where the transmission image data is stored, an image to be transmitted, a transmission destination, and can determine the various image processing modes (e.g., resolution) in the transmission. After accomplishing various settings, the user can instruct start of a transmission action through a key provided in the operating section 109. Similar to the above-described “send” function, the transmission destination can be the PC-B 140 or the PC-C 150 on the LAN 120, or the PC-D 170 connected to the Internet 160, or an MFP (not shown).

The image storage section 108 sends the image data to be transmitted (i.e., the image data stored in the above-described box) as JPEG compressed RGB data to the compression/expansion processing section 105 via the data path control section 107. The flow of image data transferred in the above processing is indicated by a data path 6001 in FIG. 6.

The compression/expansion processing section 105 performs the JPEG expansion processing for the entered RGB multi-value JPEG compressed image data. The compression/expansion processing section 105 sends the RGB multi-value image data (i.e., image data having been subjected to the JPEG expansion processing) to the image processing section 102 via the data path control section 107. The flow of image data transferred in the above processing is indicated by a data path 6002 in FIG. 6.

The image processing section 102 performs various image processing for the entered RGB multi-value image data and sends the processed RGB multi-value image data to the data path control section 107. The memory 103 stores the RGB multi-value data. The flow of image data transferred in the above processing is indicated by a data path 6003 in FIG. 6.

After the image data is stored in the memory 103, the memory 103 sends the RGB multi-value data via the data path control section 107 to the compression/expansion processing section 105. The flow of image data transferred in the above processing is indicated by a data path 6004 in FIG. 6.

The compression/expansion processing section 105 performs the JPEG compression processing for the RGB multi-value image data (i.e., non-compressed image data). The compression/expansion processing section 105 sends the JPEG image data to be attached to an electronic mail (i.e., RGB multi-value image data having been subjected to the JPEG compression processing), via the data path control section 107, to the external I/F 106. The flow of image data transferred in the above processing is indicated by a data path 6005 in FIG. 6.

The external I/F 106 performs processing for attaching the entered RGB multi-value JPEG image data, as an attached file, to an electronic mail created beforehand according to the settings entered from the operating section 109, and outputs the electronic mail to the LAN 120. The flow of data in the above transfer processing is indicated by a data path 6006 in FIG. 6.

Similar to the above-described “send” action, the electronic mail including an attached file is sent from the external I/F 106 of the MFP-A 100 to a transmission destination connected to the LAN 120. The flow of electronic mail is indicated by a data path 5006 in FIG. 5. The transmission destination can be the PC-B 140 or the PC-C 150 connected to the LAN 120, or the PC-D 170 connected to the Internet 160. The flow of electronic mail is indicated by data paths 6007 and 6008 in FIG. 6.

A user can input settings relating to the “box to send” action through the operating section 109. The CPU 110 can input “box to send” settings. Each processing section of the MFP-A 100 performs a designated action under the control of CPU 110. The CPU 110 sends data to the operating section 109 for a screen display enabling a user to perform settings and a display of an operation state of the MFP-A 100 that executes the “box to send” action. A user can confirm the data displayed on the display section 902. The transmission/reception of the data in the settings is indicated by two data paths 6009 and 6010 in FIG. 6.

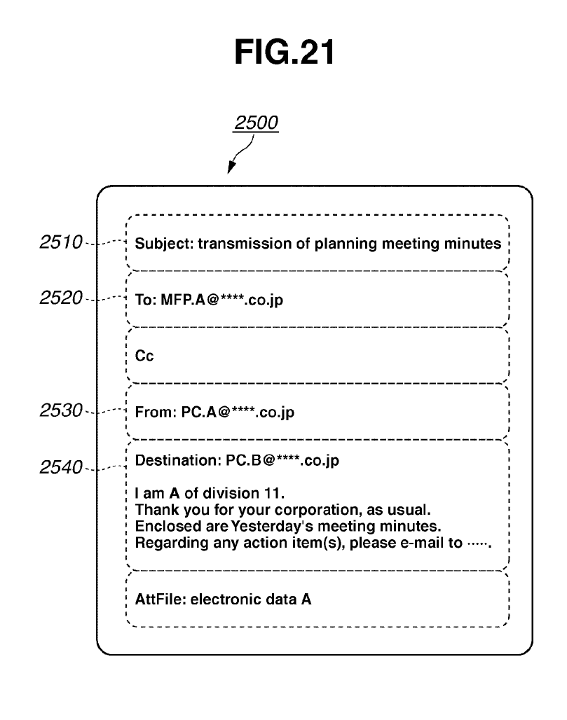

Next, with reference to FIGS. 21 through 27, an electronic mail transmission action performed via an MFP will be described according to the present embodiment.

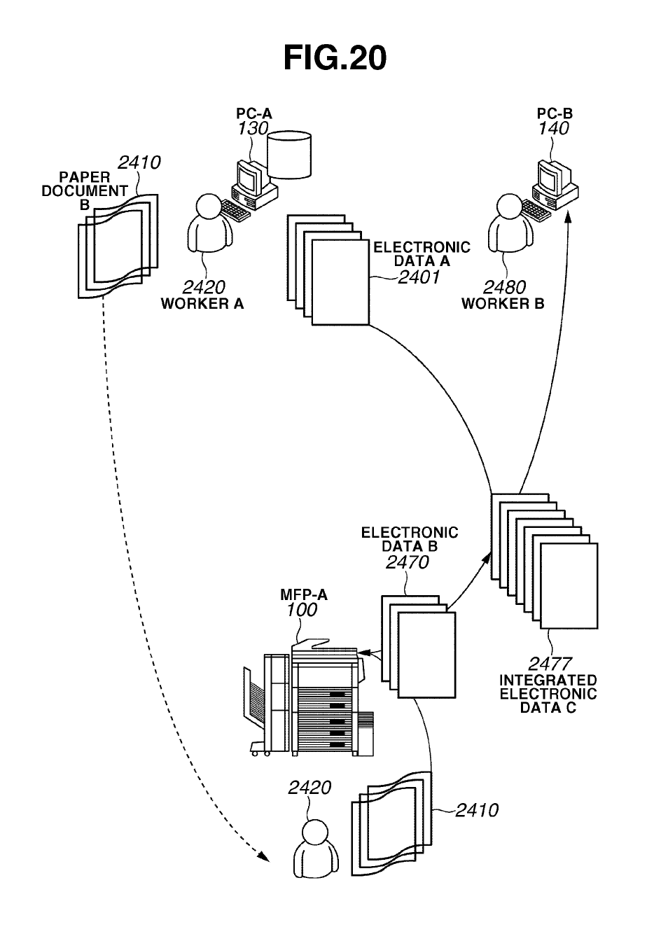

FIG. 20 illustrates an exemplary electronic mail transmission action performed via an MFP according to the present exemplary embodiment. A worker (i.e., user) A 2420 of the PC-A 130 performs the following processing:

(1) The worker A 2420 desires to obtain electronic data B 2470 of a paper document B 2410 and combine the electronic data B 2470 with electronic data A 2401 stored in the PC-A 130 to form integrated electronic data C 2477. The electronic data A 2401 can be a file of image data or document data. Furthermore, electronic data B 2470 of a paper document B can be a file of image data or text data obtainable through character recognition processing applied to the image data.

(2) The worker A 2420 desires to transmit an electronic mail including the integrated electronic data C 2477 to a worker (i.e., user) B 2480 of the PC-B 140. The worker A 2420 further desires to add a message as part of the text in the electronic mail.

In order to realize (1) and (2), the worker A 2420 uses the PC-A 130 and the MFP-A 100 of the present embodiment.

More specifically, the worker A 2420 is a user of the PC-A 130. The PC-A 130 can realize electronic mail transmission/reception processing using pre-installed software. An electronic mail address (e.g., PC.A@****.co.jp) of the worker A 2420 is set beforehand in the PC-A 130.

First, the worker A 2420 operates the PC-A 130 to create an electronic mail 2500 shown in FIG. 21. The electronic mail 2500 includes an attached file of electronic data A 2401 stored in the PC-A 130. A title field (i.e., “Subject”) 2510 of the electronic mail 2500 is “transmission of planning meeting minutes.” The electronic mail 2500 includes an electronic mail address of MFP-A 100 (MFP-A@****.co.jp) in a destination field (i.e., “To”) 2520 and an electronic mail address of the worker A 2420 of the PC-A 130 in a sender field (i.e., “From”) 2530. A character string 2540 includes an electronic mail address of the worker B 2480 (i.e., final destination of the electronic mail). In addition, a message can be included in the character string 2540.

When the worker A 2420 instructs transmission of the electronic mail 2500, the PC-A 130 transmits the electronic mail 2500 to the MFP-A 100. The MFP-A 100 analyzes the received electronic mail 2500 and separates the attached file (i.e., electronic data A 2401) from the electronic mail text.

Since the attached file of the electronic mail 2500 is character encoded, the MFP-A 100 performs predetermined decode processing to separate electronic data A 2401. Then, the MFP-A 100 creates a temporary file including the text of the electronic mail 2500 and the electronic data A 2401 correlated to user information of the worker A 2420, and stores the temporary file in a predetermined temporary area of the image storage section 108. The temporary area is referred to as a temporary box.

Subsequently, the worker A 2420 carries the paper document B 2410 to the MFP-A 100. The worker A 2420 performs a predetermined operation for user authentication to log in the MFP-A 100. For example, the worker A 2420 is required to input a user ID and a password through the operating section of the MFP-A 100, or is required to use an IC card or a biometrics mechanism.

The MFP-A 100 has an internal or external database (e.g., a directory server) that can store user information. With reference to the user information, the MFP-A 100 can determine whether a user having performed a log-in operation is authorized to operate the MFP-A 100 and can permit the user to operate the MFP-A 100. If the MFP-A 100 can accurately authenticate the worker A 2420, the operating section 109 of the MFP-A 100 displays the presence of an electronic mail received beforehand from the worker A 2420 and stored in the temporary box. Alternatively, the worker A 2420 can perform a predetermined operation on the operating section 109 to directly access the temporary box.

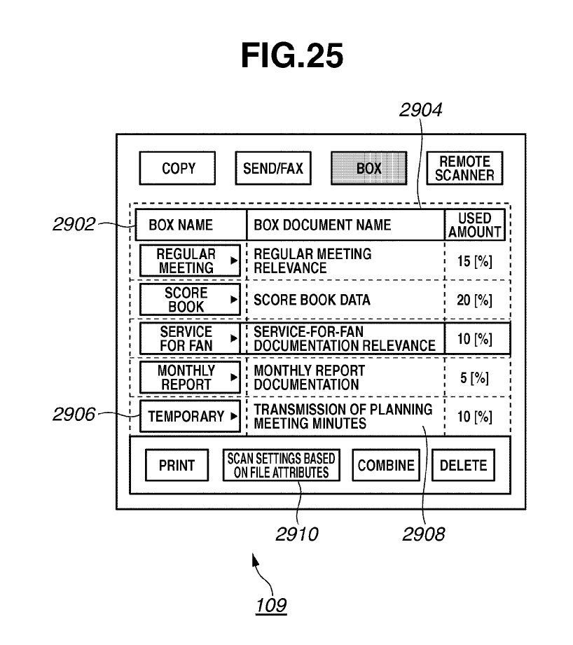

FIG. 25 illustrates an exemplary list display screen including a temporary box which can be displayed on the operating section 109. According to the example illustrated in FIG. 25, a temporary box field 2906 is displayed at the lowest position in a box name field 2902. A document name, i.e., the title (i.e., “Subject”) 2510 of the electronic mail 2500, is displayed at the lowest position in a box document name field 2904. Thus, the worker A 2420 can confirm the presence of the electronic data A 2401 attached to the electronic mail 2500.

If any user other than the worker A 2420 logs in the MFP-A 100, the title of the electronic mail 2500 cannot be displayed in the temporary box field 2906. Thus, other users are not aware of the presence of the electronic mail 2500 transmitted by the worker A 2420.

The worker A 2420 designates a document in the temporary box through the operating section 109, while the worker A 2420 instructs the MFP-A 100 to scan the paper document B 2410. The MFP-A 100 scans the paper document B 2410 and creates the electronic data B 2470 by performing an action similar to the “scan to box” action illustrated in FIG. 3. [0131] Then, the MFP-A 100 combines the electronic data A 2401 with the electronic data B 2470 to create the integrated electronic data C 2477. The MFP-A 100 can automatically perform various settings (e.g., reading resolution, color, and monochrome) in the scan instruction with reference to attribute information of the electronic data A 2401 as described below.

Then, the MFP-A 100 creates an electronic mail 2600 and sends it to a destination 2620.

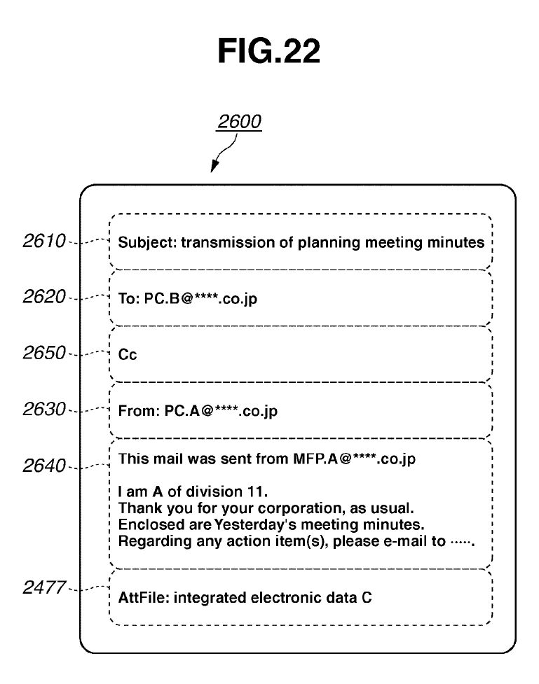

FIG. 22 illustrates an example of the electronic mail 2600. A title (i.e., “Subject”) 2610 of the electronic mail 2600 is “transmission of planning meeting minutes”, which is identical to the title 2510 of the electronic mail 2500.A destination (i.e., “To”) 2620 is an electronic mail address (PC.B@****.co.jp) of the worker B 2480, i.e., the final destination of the electronic mail, described in the text of the electronic mail 2500.A sender (i.e., “From”) 2630 is the electronic mail address of the worker A 2420, i.e., the transmission source of the electronic mail 2500, not the mail address of the MFP-A 100. The electronic mail 2600 includes, in the text 2640, a message indicating the fact that the mail was transmitted from the MFP-A 100. An attached file of the electronic mail 2600 is the integrated electronic data C 2477.

The worker B 2480 receives the electronic mail 2600 at the PC-B 140, and can read the electronic mail text displayed on a display screen of the PC-B 140. Furthermore, the worker B 2480 can obtain the integrated electronic data C 2477 attached to the electronic mail 2600.

The worker B can recognize that the transmission source is the worker A 2420 based on the sender (i.e., “From”) 2630 of the electronic mail 2600. Furthermore, the worker B can know that the electronic mail 2600 was transmitted from the MFP-A 100 based on the message in the text.

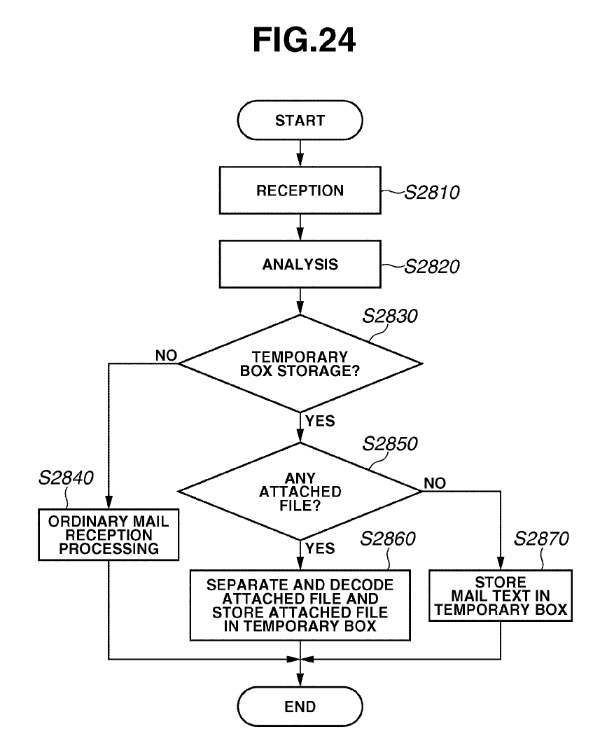

FIG. 24 is a flowchart illustrating electronic mail reception processing performed by the MFP-A 100 according to the present embodiment. To realize the processing of the flowchart illustrated in FIG. 24, the CPU 110 of the MFP-A 100 loads a program stored in the ROM 111 or in the image storage section 108 into the memory 103 and executes the program.

In step S2810, the MFP-A 100 receives an electronic mail from the PC-A 130. Then, in step S2820, the MFP-A 100 analyzes the electronic mail, and determines whether the electronic mail includes any attached file. In addition, the MFP-A 100 determines whether a character string 2540 (i.e., destination) indicating the final destination is present in the text of the electronic mail.

In step S2830, based on the analysis result obtained in step S2820, the MFP-A 100 determines whether the received electronic mail can be stored in the temporary box. If the character string 2540 indicating the final destination is present, the MFP-A 100 stores the electronic mail in the temporary box in step S2860 or step S2870. [0138] Any other determination method can be used in step S2830 that would enable practice of the present invention. For example, a command indicating the temporary box as a storage portion of the electronic mail can be described in the text or in a specific header of the electronic mail 2500.

In step S2830, the MFP-A 100 would determine whether the received electronic mail can be stored in the temporary box or subjected to the ordinary reception processing based on the presence of the command.

If the received electronic mail cannot be stored in the temporary box (i.e., NO in step S2830), the processing flow proceeds to step S2840. In step S2840, the MFP-A 100 performs the ordinary electronic mail processing (e.g., print processing, box storage processing, transfer processing, and predetermined image processing) and then terminates the processing of this routine.

When the received electronic mail can be stored in the temporary box (i.e., YES in step S2830), the processing flow proceeds to step S2850. In step S2850, the MFP-A 100 determines, based on the analysis result obtained in step S2820, whether the received electronic mail includes any attached file If the received electronic mail includes an attached file (i.e., YES in step S2850), the processing flow proceeds to step S2860. When the received electronic mail does not include an attached file (i.e., NO in step S2850), the processing flow proceeds to step S2870.

In step S2860, the MFP-A 100 separates the attached file from the electronic mail and decodes the file. Then, the MFP-A 100 correlates the decoded file with the text of the electronic mail and stores them together in the temporary box. Then, based on the sender (i.e., “From”) of the electronic mail, the MFP-A 100 correlates the electronic mail with a user account of the user in the MFP-A 100 (i.e., user information required to log in the MFP-A 100). Then, the MFP-A 100 terminates the processing of this routine. The user account in the MFP-A 100 (e.g., a user ID entered in a log-in operation) and the information relating to a corresponding electronic mail address can be stored as a table in the image storage section 108 of the MFP-A 100. The table can be managed in an external directory server (not shown). The MFP-A 100 can obtain a user account from its table or from directory server, with reference to the electronic mail address information.

In step S2870, the MFP-A 100 stores the text of the electronic mail into the temporary box. Then, based on the sender (i.e., “From”) of the electronic mail, the MFP-A 100 correlates the electronic mail with the user account of the user in the MFP-A 100. Then, the MFP-A 100 terminates the processing of this routine.

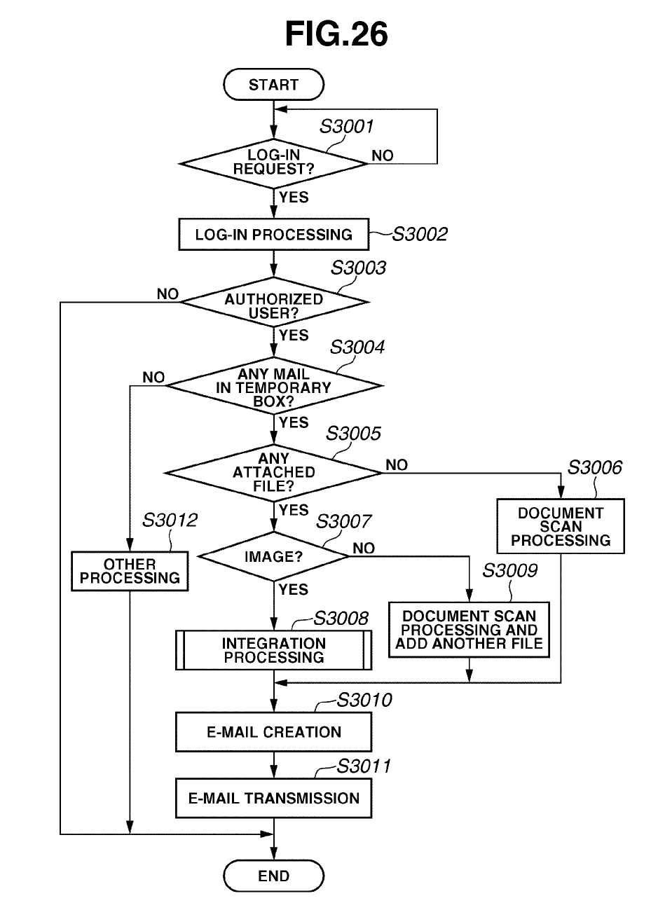

FIG. 26 is a flowchart illustrating electronic mail transmission processing performed by the MFP-A 100 to transmit an electronic mail stored in the temporary box according to the present embodiment. To realize the processing of the flowchart illustrated in FIG. 26, the CPU 110 of the MFP-A 100 loads a program stored in the ROM 111 or in the image storage section 108 into the memory 103 and executes the program.

In step S3001, the MFP-A 100 waits for a user's log-in (i.e., user authentication) request. If a log-in request is received (i.e., YES in step S3001), the MFP-A 100 performs log-in processing (step S3002). The log-in processing can be realized by collating a user ID and a password received from the operating section 109 with the information stored in the MFP-A 100 or in the external directory server. Alternatively, the log-in processing can be realized by performing the user authentication using an IC card or biometrics.

In step S3003, the MFP-A 100 determines whether the log-in request is received from an authorized user based on the result of step S3002. If the log-in request is received from an authorized user (i.e., YES in step S3003), the processing flow proceeds to step S3004. When the log-in request is received from an unauthorized user (i.e., NO in step S3003), the MFP-A 100 terminates the processing of this routine.

In step S3004, the MFP-A 100 determines whether any electronic mail related to the log-in user is present in the temporary box. In the temporary box, each electronic mail can be stored together with the user account correlated in step S2860 or step S2870 of FIG. 24. Accordingly, the MFP-A 100 checks if any electronic mail related to a log-in user account is present in the temporary box.

When no electronic mail related to the log-in user is present in the temporary box (i.e., NO in step S3004), the processing flow proceeds to step S3012. In step S3012, the MFP-A 100 executes any other processing based on the user's operation and terminates the processing of this routine. On the other hand, if an electronic mail related to the log-in user is present in the temporary box (i.e., YES in step S3004), the processing flow proceeds to step S3005. In step S3005, the MFP-A 100 determines whether any file is attached to the electronic mail stored in the temporary box.

When no file is attached (i.e., NO in step S3005), the processing flow proceeds to step S3006. In step S3006, the MFP-A 100 scans a paper document which is set by the user. Then, the MFP-A 100 creates image data to be attached to an electronic mail. When a file of created image data is attached to an electronic mail, a user can input a file name through the operating section 109 or the MFP-A 100 can automatically create a file name.

When an attached file is present (i.e., YES in step S3005), the processing flow proceeds to step S3007. In step S3007, the MFP-A 100 determines whether the attached file is image data. The determination in step S3007 is performed because a document file created by word-processing software (i.e., data other than image data) cannot be combined with paper document image data as a single file. If the attached file is image data (i.e., YES in step S3007), the processing flow proceeds to step S3008. If the attached file is not image data (i.e., NO in step S3007), the processing flow proceeds to step S3009.

In step S3008, the MFP-A 100 performs integration processing. The integration processing is processing for integrating an attached file of an electronic mail with scanned document image data into a single file, as described below. A user can input a file name of the integrated file through the operating section 109, or the MFP-A 100 can automatically create a file name. Furthermore, a file name of an attached file stored in the temporary box (i.e., combination target) can be directly used.

In step S3009, the MFP-A 100 performs the processing for scanning a paper document which is set by a user. Then, the MFP-A 100 creates image data to be attached to an electronic mail. However, in this case, the file attached to an electronic mail is not image data, and accordingly the integration processing of step S3008 is not performed. Accordingly, in step S3009, the MFP-A 100 performs the processing for adding another file of scanned document image data different from the attached file of the electronic mail.

In step 3010, the MFP-A 100 creates an electronic mail by attaching the file created in step S3006 or in step S3008 or in step S3009 to the text of an electronic mail stored in the temporary box. To create a transmission electronic mail, the MFP-A 100 sets a destination based on the character string (corresponding to 2540 of FIG. 21) including an electronic mail address indicating a final destination described in the text of an electronic mail stored in the temporary box. Then, the MFP-A 100 sets, as a sender, the sender of an electronic mail stored in the temporary box (corresponding to step 2630 of FIG. 22). Then, the MFP-A 100 deletes the destination described in the text of an electronic mail stored in the temporary box. The MFP-A 100 inserts, into the transmission electronic mail, a message indicating the fact that the electronic mail was transmitted from the MFP-A 100 (corresponding to step 2640 of FIG. 22). Then, in step S3011, the MFP-A 100 transmits the electronic mail created in step S3010 and terminates the processing of this routine.

In the present embodiment, the final destination included in the character string 2540 is not limited to an electronic mail address. For example, the final destination can be a telephone number. The MFP-A 100 can convert the electronic mail and the attached file stored in the temporary box into a facsimile image, and can transmit a facsimile image to a designated final destination identified by the telephone number. Furthermore, the final destination can be a destination accessible using the File Transfer Protocol (FTP) transmission method or the Service Message Block (SMB) transmission method.

In addition, instead of performing the combination processing in step S3008, a scanned paper document image data can be created as an independent file different from the attached file of an electronic mail stored in the temporary box and the created file can be attached as another file to the electronic mail. A user can arbitrarily determine whether the combination processing can be performed, for example, when the paper document B 2410 is scanned or beforehand.

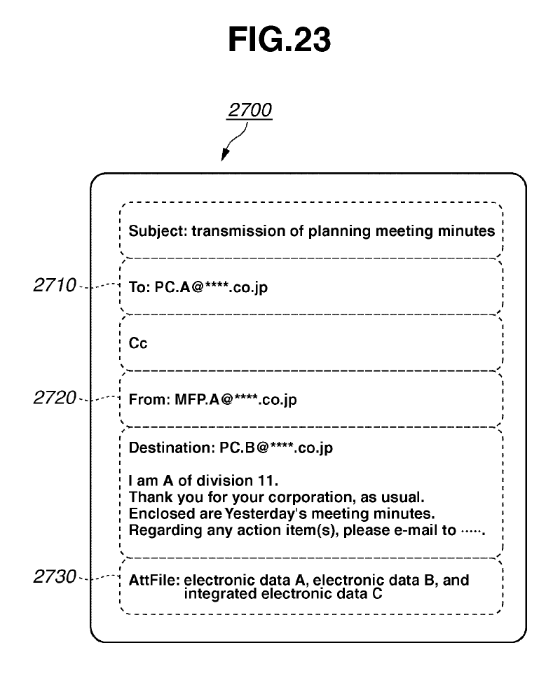

An electronic mail 2700 as illustrated in FIG. 23, different from the electronic mail transmitted in step S3011 of FIG. 26, can be separately created and transmitted to an electronic mail address of the worker A 2420. The electronic mail 2700 includes an electronic mail address of the PC-A 130 in a destination field 2710 (i.e., “To”) and an electronic mail address of the MFP-A 100 in a sender field 2720 (i.e., “From”). Furthermore, the electronic mail 2700 includes the electronic data A 2401, the electronic data B 2470, and the integrated electronic data C 2477 as attached files in an attachment field 2730.

The above allows the worker A 2420 to use the electronic data B 2470 by transmitting the electronic data B 2470 to the worker A 2420 when electronic data B 2470 was created by scanning the paper document B 2410 by the MFP-A 100. The attached file can be only the electronic data B 2470, or can be only the integrated electronic data C 2477. A user can arbitrarily designate an attached file when the electronic mail 2700 is transmitted or beforehand in the settings.

Alternatively, instead of separately creating the electronic mail 2700, an electronic mail address of the worker A 2420 can be added as a destination in the electronic mail 2600 illustrated in FIG. 22. In this case, the MFP-A 100 adds the electronic mail address of the worker A 2420 in the destination field (i.e., “To”) 2620 or in the broadcast field 2650 (i.e., “Cc”).

Alternatively, instead of scanning a paper document to create image data in steps S3006, S3008, and S3009, the image data stored in the box can be designated, for by example, by the user. In this case, in step S3010, the MFP-A 100 creates an electronic mail including the designated box storage image obtainable through attachment or integration processing.

Through the above-described processing, the electronic mail created by the PC-A 130 can be combined or integrated with the paper document image data scanned by the MFP-A 100. The combined or integrated data can be transmitted to the PC-B 140 (i.e., final destination). Thus, the work for attaching paper document image data scanned by the MFP to an electronic mail text created by a PC can be simplified.

Furthermore, when an electronic mail created by a PC is transmitted via an MFP to a final destination, both the destination (i.e., “To”) and the sender (i.e., “From”) of the electronic mail can be appropriately set. Thus, the worker B 2480 (i.e., a final recipient of the electronic mail) can recognize the fact that the electronic mail was transmitted from the worker A 2420.

Next, the processing performed in step S3008 of FIG. 26, i.e., the processing for integrating image data obtained by scanning a paper document image with image data stored in the temporary box, will be described.

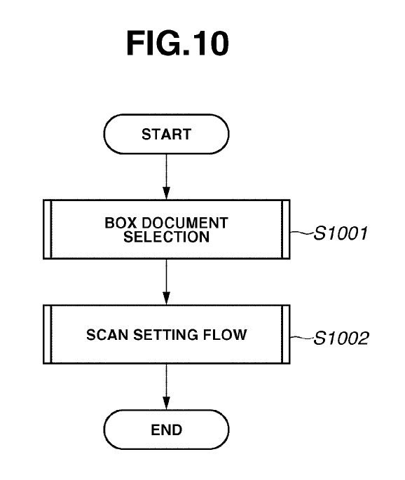

FIG. 10 is a flowchart illustrating the integration processing according to the present embodiment. The CPU 110 of the MFP-A 100 can execute the processing of the flowchart illustrated in FIG. 10. First, the MFP-A 100 executes a box document selection flow for selecting a box document stored in the box (refer to step S1001) and then executes a scan setting flow for setting scan (document reading) parameters (refer to step S1002).

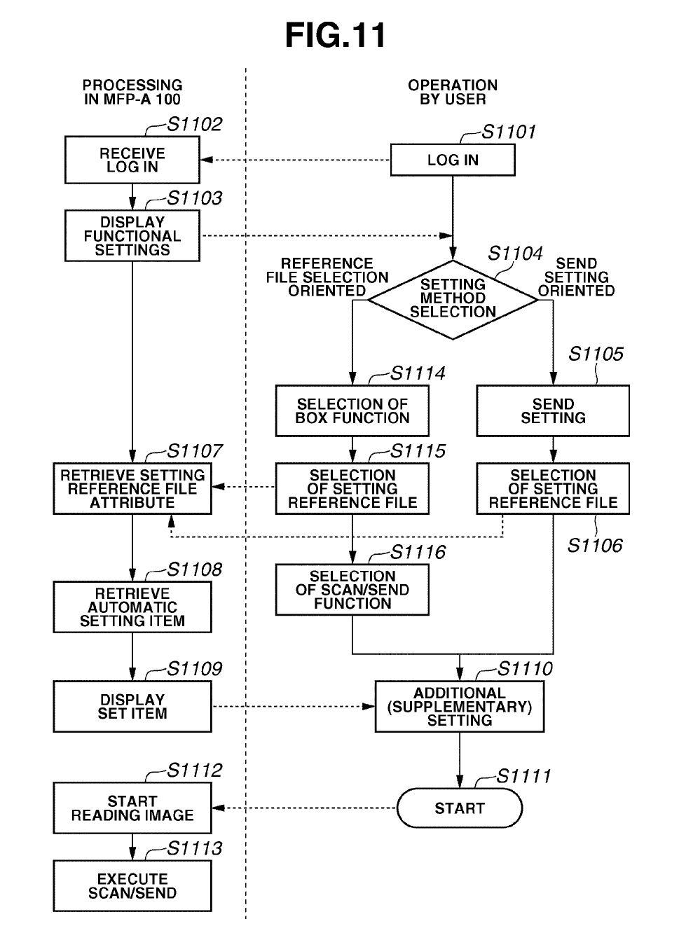

FIG. 11 illustrates details of the flowchart illustrated in FIG. 10. In FIG. 11, the left half of the flowchart is the processing performed by the MFP-A 100, and the right half of the flowchart is the processing performed by a user.

First, a user logs in the MFP-A 100 (refer to step S1101). The log-in operation by the user (i.e., user authentication) can be performed through the operating section 109 of the perform MFP-A 100. The MFP-A 100 receives a log-in request from the user (refer to step S1102), and displays a function setting screen (refer to step S1103). Then, the user selects a setting method for the scan parameters (refer to step S1104).

If the user selects a “send setting oriented” mode in step S1104, the MFP-A 100 displays a send setting screen, described below, on the display section 902. To perform a “Send” operation, the user performs transmission destination settings (refer to step S1105). Subsequently, the user selects a reference file for scan settings (refer to step S1106).

On the other hand, when the user selects a “reference file selection oriented” mode in step S1104, the user selects a “box” function, described below, (refer to step S1114) and selects a setting reference file (refer to step S1115). After finishing the selection of a scan setting reference file, the user selects a scan function or a send function (refer to step S1116).

When the user selects a scan setting reference file according to one of the above-described setting methods, the MFP-A 100 retrieves the attribute of the setting reference file (refer to step S1107). Subsequently, the MFP-A 100 retrieves automatically settable items with respect to the scan action (refer to step S1108). The MFP-A 100 automatically sets the settable items as parameters and displays setting contents on the operation screen (refer to step S1109).

When the MFP-A 100 finishes the automatic scan (read) settings and the display of setting contents, the user can perform additional or supplemental settings (refer to step S1110). Items in the additional or supplemental settings include, but are not limited to, designation of a “two-sided” document. Next, the user selects a start key (refer to step S1111). The MFP-A 100 starts a scanning (i.e., image reading) operation (refer to step S1112) and also executes a scan/send processing (refer to step S1113).

When the processing of step S3008 in FIG. 26 is executed, the log-in operation of step S1101 is already performed and therefore can be omitted. In this case, the “reference file selection oriented” mode is automatically selected in step S1104 and the “send” function is selected in step S1116.

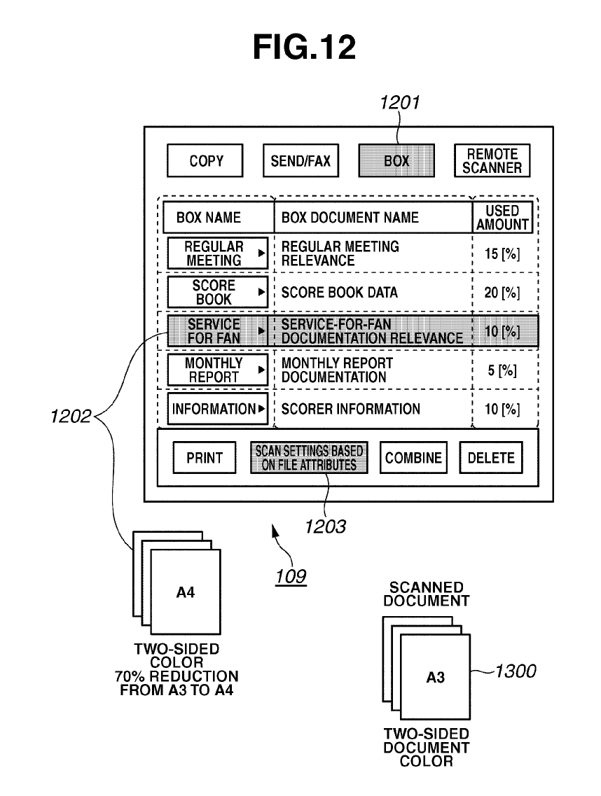

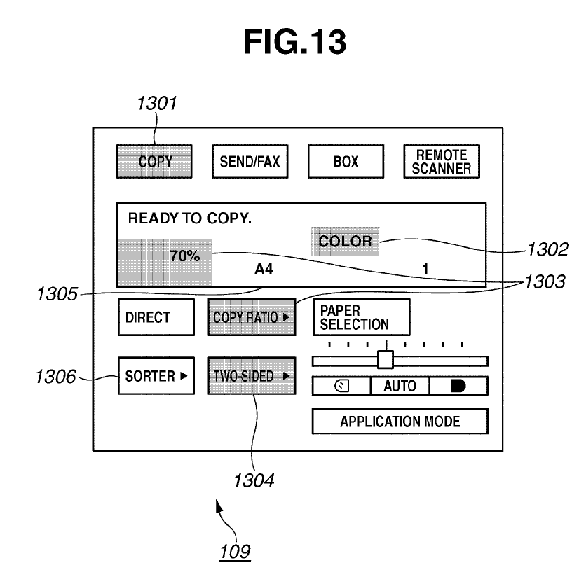

Operation examples, including the operating section, using the scan setting method will be described below with reference to FIGS. 12 through 19.

### OPERATION EXAMPLE 1

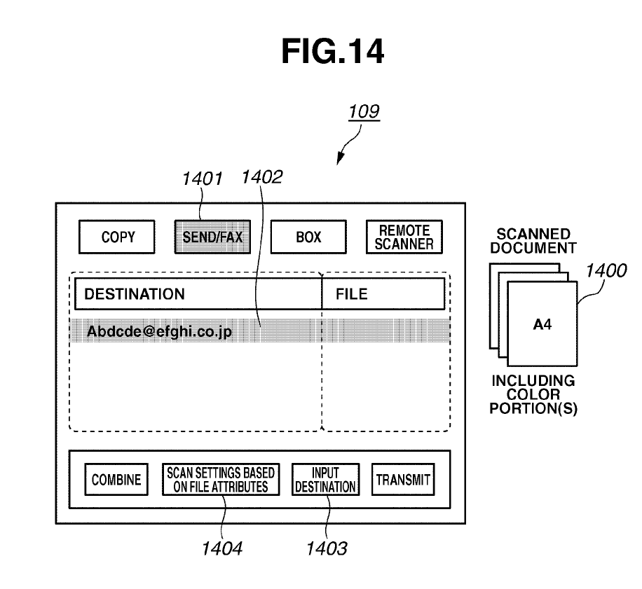

FIGS. 14 through 16 show a first exemplary operation for combining a box document with scanned document image data based on automatic scan function settings and sending an electronic mail including an integrated document.

The following is information with respect to the box document combined with the scanned document image data:

Scanned document 1400: A4-size document including a color portion; and

Box document 1500: A4-size document formatted as a JPEG image file with the resolution equal to 300 dpi and including a color image.

The information with respect to the scanned document and the box document is not limited to the above listed information, and any additional information related to either the scanned document or box document can be included. These documents are combined and sent as an attached file of an electronic mail.

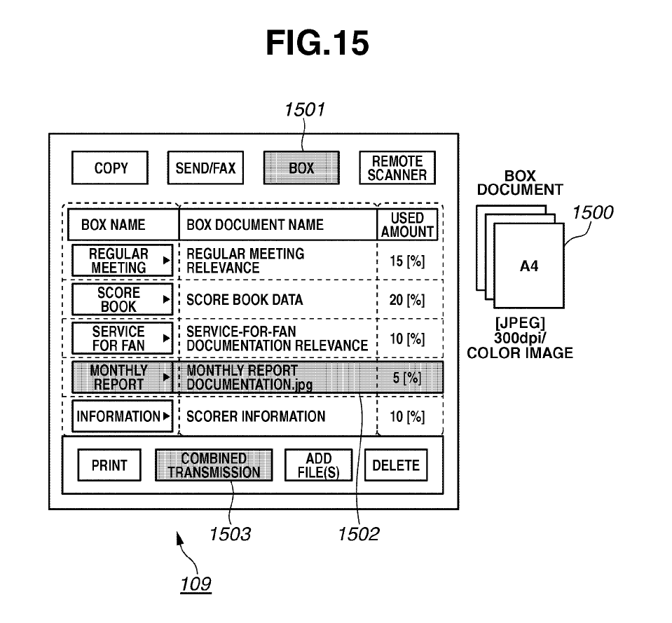

First, a user selects a send/FAX tab 1401 on the operating section 109. Then, the user selects a destination (input destination) 1403 and inputs an electronic mail address. A mail address 1402 of a communication partner is displayed. Subsequently, the user selects a “scan settings based on file attributes” 1404 to activate a box tab 1501, and a screen illustrated in FIG. 15 is displayed.

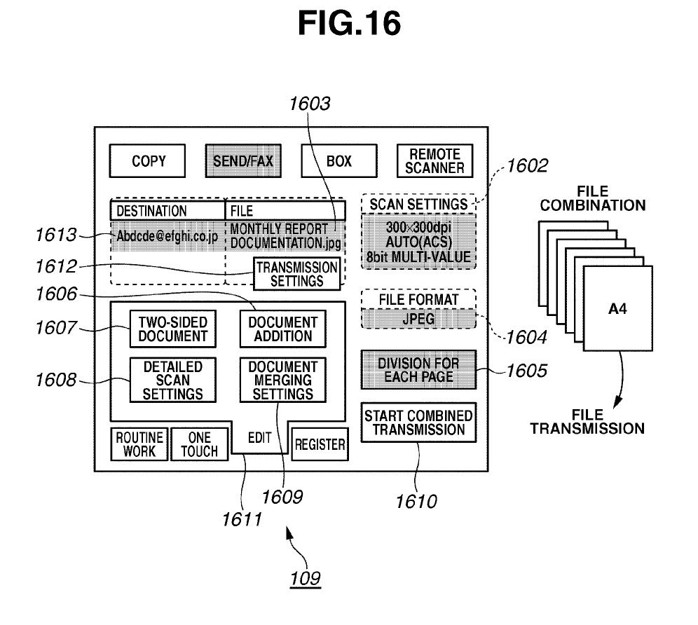

The user selects a box document “monthly report documentation.jpg” 1502 on the operating section 109 as a target for the scan settings, i.e., an object to be combined with the document image data. Subsequently, the user selects a “combined transmission” key 1503 on the operating section 109. The operating section 109 displays a “send/FAX” setting screen as shown in FIG. 16. In the present embodiment as described in FIGS. 24 to 30, the screen as illustrated in FIG. 16 is displayed after the user selects the document 2908 in the temporary box in the screen illustrated in FIG. 29. In this case, the operation section 109 displays “Transmission of Planning Meeting Minutes” as the file name 1603, and displays the e-mail address “Abcde@efghi.co.jp” as the destination 1613.

The screen of FIG. 16 includes a file name “monthly report documentation.jpg” 1603 of the attached box document in addition to the electronic mail address of a transmission destination, as the user selected the “combined transmission” key 1503 on the screen of FIG. 15. The “monthly report documentation.jpg” is a file which is not yet combined. The following are file attributes resulting from the retrieval processing and determined as items (parameters) automatically set:

Scan settings 1602: 300 dpi×300 dpi, ACS (automatic color/monochrome selection), and 8 bit multi-value;

File format 1604: JPEG;

Division for each page 1605: effective; and

File name 1603: file name of combined box document.

The file attributes that can be automatically set are not limited to those described above.

Once the settings have been accomplished, the result is displayed to the user. The user can add additional setting items based on the items having been automatically set.

An “edit” tab 1611 includes a “two-sided document” key 1607, which enables a user to scan a two-sided document. The “edit” tab 1611 also includes a “document addition” key 1606, a “detailed scan settings” key 1608, a “document merging settings” key 1609, and a “combined file name change” (not shown). The “document addition” key 1606 enables a user to add a document to be combined. The “detailed scan settings” key 1608 enables a user to determine detailed scan settings. The “document merging settings” key 1609 enables a user to determine the page and position of a box document where the scanned document image data is inserted.

Selection of the “document merging settings” key 1609 enables a user to determine default settings. For example, the default settings may include an item “combined to the last of a document in the absence of settings”. If the system includes a user authentication function, the setting information can be stored for each user.

After completing the above-described supplementary settings, the user selects a “start combined transmission” key 1610. Upon selection of the “start combined transmission” key 1610, the MFP-A 100 initiates a “scan” action, a “combination” action, and a “send” action.

In another exemplary embodiment, only the scan settings can be obtained without performing the combination with a designated box document. To accomplish this, a selection item “transmit only scanned file” (not shown) is added in the menu displayed when a “transmission settings” key 1612 is selected. In addition, the label of the “start combined transmission” key 1610 can be replaced with an ordinary name such as “start transmission” to enable a user to start the “send” action.

In still yet another embodiment, when the processing of step S3008 in FIG. 26 is executed, the “send” function can be automatically determined by selecting an electronic mail in the temporary box. Thus, a user need not select the “send” function. The screen illustrated in FIG. 25 is displayed when the processing of step S3008 in FIG. 26 is executed. Using this screen, a user selects an electronic mail stored in the temporary box 2906, i.e., “transmission of planning meeting minutes” 2908, and selects a “scan settings based on file attributes” 2910.

### OPERATION EXAMPLE 2

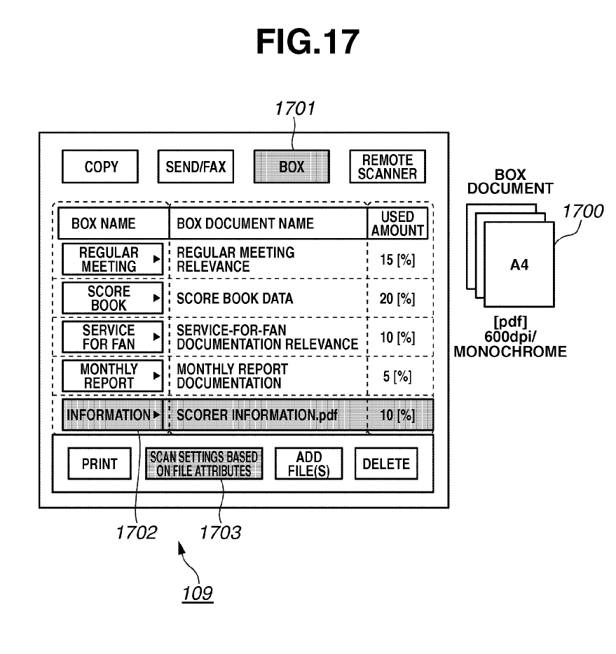

FIGS. 17 through 19 illustrate a second exemplary operation. Similar to the first exemplary operation, the second exemplary operation combines a box document with scanned document image data based on automatic scan function settings and sends an electronic mail including an integrated document. The procedure/process of the second exemplary operation is different from the procedure/process of the first exemplary operation. The second exemplary operation corresponds to an action performed when the “reference file selection oriented” mode is selected in step S1104 of the flowchart illustrated in FIG. 11.

The following is information with respect to the box document combined with the scanned document:

Scanned document 1900: A3-size document including a color portion (to be combined as a monochrome portion); and

Box document 1700: A4-size document formatted as a PDF file with the resolution equal to 600 dpi and including a monochrome image.

The information with respect to the scanned document and the box document is not limited to the above listed information, and any additional information related to either the scanned document or the box document can be included. These documents are combined and sent as an attached file of an electronic mail.

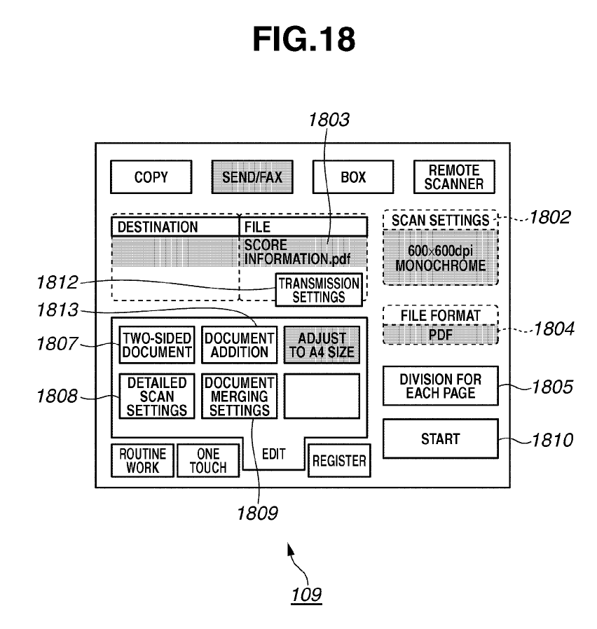

Turning to FIG. 17, a user selects a “box” tab 1701 to display a box screen illustrated in FIG. 17. The user selects a box document “scorer information.pdf” 1702 which is a target to be referred to for the scan settings and an object to be combined with the document image data. Subsequently, the user selects a “scan settings based on file attributes” key 1703, and starts scan settings using the screen illustrated in FIG. 18.

If the transmission settings have been completed beforehand, the “combined transmission” key 1503 will be displayed. However, in the present operation, execution of the combined transmission has not been determined. Thus, the “scan settings based on file attributes” key 1703 is displayed.

The scan setting screen illustrated in FIG. 18 includes parameters automatically settable based on the setting information obtained from the box document designated as an object to be combined in the screen illustrated in FIG. 17. The parameters include, but are not limited to:

Scan settings 1802: 600 dpi×600 dpi and monochrome;

File format 1804: PDF;

Division for each page 1805: ineffective; and

File 1803: box document file displayed as combination target.

In present operation, similar to the above-described first exemplary operation, the “edit” tab includes the menus used for additional settings. The menus include a “two-sided document” key 1807, an “adjust to A4 size (i.e., a paper size of a combination target document)” key 1813 to automatically adjust the size of the document to A4 to perform the combination if the scanned paper is not A4 size.

In addition, similar to the above-described first exemplary operation, in the present operation, a user performs detailed settings by switching the screen. As such, the “edit” tab includes a “detailed scan settings” key 1808, a “document addition” key 1813, and a “document merging settings” key 1809.

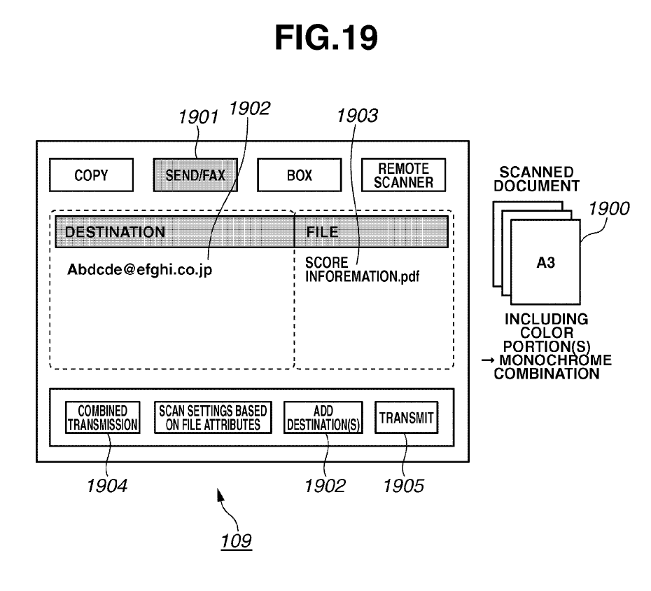

In order to set transmission settings, the user selects a “transmission settings” key 1812 to display a screen illustrated in FIG. 19. When the user inputs an electronic mail address of the transmission destination, the entered electronic mail address 1902 is displayed in the destination field. Furthermore, a box document name 1903 (i.e., the name of a box document to be combined and transmitted) is displayed in the “file” field. Subsequently, the user selects a “combined transmission” key 1904. Upon selection of the “combined transmission” key 1904, the MFP-A 100 initiates a “scan” action, a “combination” action, and a “send” action. As such, similar to the first exemplary operation, in the present operation, a user can perform transmission without any combination, overwrite a box document with a combined box document, and use an arbitrary name for a stored document.

The functions of the above-described embodiments can be realized using software program code which can be supplied to a system or an apparatus connected to various devices. A computer (or CPU or micro-processing unit (MPU)) in the system or the apparatus can execute the program to operate the devices to realize the functions of the above-described exemplary embodiments. Accordingly, the present invention encompasses the program code installable in a computer when the functions or processes of the exemplary embodiments can be realized by the computer.

In this case, the program code itself can realize the functions of the exemplary embodiments. The equivalents of programs can be used if they possess comparable functions. Furthermore, the present invention encompasses the means for supplying the program code to a computer, such as a storage (or recording) medium storing the program code.

In this case, the type of program can be any one of object code, interpreter program, and OS script data. A recording medium supplying the program can be selected from any one of a floppy disk, a hard disk, an optical disk, a magneto-optical (MO) disk, a compact disk-ROM (CD-ROM), a CD-recordable (CD-R), a CD-rewritable (CD-RW), a magnetic tape, a nonvolatile memory card, a ROM, and a DVD (DVD-ROM, DVD-R)

The method for supplying the program includes accessing a home page on the Internet using the browsing function of a client computer, when the home page allows each user to download the computer program of the present invention, or compressed files of the programs having automatic installing functions, to a hard disk or other recording medium of the user.

Furthermore, the program code constituting the programs of the present invention can be divided into a plurality of files so that respective files are downloadable from different home pages. Namely, the present invention encompasses WWW servers that allow numerous users to download the program files so that the functions or processes of the present invention can be realized on their computers.

Furthermore, enciphering the programs of the present invention and storing the enciphered programs on a CD-ROM or comparable recording medium is an exemplary method when the programs of the present invention are distributed to the users. The authorized users (i.e., users satisfying predetermined conditions) are allowed to download key information from a page on the Internet. The users can decipher the programs with the obtained key information and can install the programs on their computers. When the computer reads and executes the installed programs, the functions of the above-described exemplary embodiments can be realized.

Furthermore, an operating system (OS) or other application software running on the computer can execute part or all of the actual processing based on instructions of the programs. The program code read out of a storage medium can be written into a memory of a function expansion board equipped in a computer or into a memory of a function expansion unit connected to the computer. In this case, based on an instruction of the program, a CPU provided on the function expansion board or the function expansion unit can execute part or all of the processing so that the functions of the above-described exemplary embodiments can be realized.

The present invention can be applied to a system including plural devices or can be applied to a single apparatus. Moreover, the present invention can be realized by supplying the program(s) to a system or an apparatus. In this case, the system or the apparatus can read the software program relating to the present invention from a storage medium.

While the present invention has been described with reference to exemplary embodiments, it is to be understood that the invention is not limited to the disclosed exemplary embodiments. The scope of the following claims is to be accorded the broadest interpretation so as to encompass all modifications, equivalent structures, and functions.

This application claims priority from Japanese Patent Application No. 2005-366560 filed Dec. 20, 2005, which is hereby incorporated by reference herein in its entirety.

What is claimed is:

1. An image communication apparatus comprising:
a reception unit configured to receive first data from an external device;
a storage unit configured to store the first data when the first data includes specific information;
a reading unit configured to read a document image and create document image data;
an addition unit configured to create a second data by adding the document image data to the first data;
a determination unit configured to determine a transmission destination of the second data based on the first data; and
a transmission unit configured to transmit the second data to the transmission destination.

2. The image communication apparatus according to claim 1, wherein the first data includes message data and first image data, and wherein the addition unit creates the second data by adding the first image data and the document image data to the message data.

3. The image communication apparatus according to claim 2, further comprising a combination unit configured to combine the first image data and the document image data as combined data, wherein the addition unit creates the second data by adding the combined data to the message data.

4. The image communication apparatus according to claim 2, further comprising a setting unit configured to set parameters used in a document image reading operation performed by the reading unit, wherein the setting unit sets the parameters based on attribute information of the first image data.

5. The image communication apparatus according to claim 1, wherein
the first data and the second data are electronic mail formatted data, wherein the determination unit determines a transmission destination described in a predetermined portion in the first data as a transmission destination of the second data, wherein the transmission unit transmits an electronic mail including the second data to the transmission destination determined by the determination unit.

6. The image communication apparatus according to claim 5, wherein
the transmission destination described in the predetermined portion in the first data is an electronic mail address described in an electronic mail text of the first data.

7. The image communication apparatus according to claim 5, wherein
an electronic mail address in a sender field of the second data is set to be an electronic mail address described in a sender field of the first data.

8. The image communication apparatus according to claim 5, wherein an electronic mail text of the second data includes a message indicating that the second data was transmitted from the image communication apparatus.

9. The image communication apparatus according to claim 1, further comprising:
an authentication unit configured to authenticate a user who uses the image communication apparatus; and
an operation display unit configured to display information relating to the first data and receive a user's operational instruction for selecting the first data, wherein
the storage unit stores the first data received by the reception unit in relation to information identifying a transmission source user of the first data, and
the operation display unit displays information indicating the first data when the user authenticated by the authentication unit is the user stored in relation to the first data.

10. The image communication apparatus according to claim 9, wherein the addition unit adds the document image data to the first data selected by the user.

11. The image communication apparatus according to claim 1, wherein predetermined image processing is performed for the first data when the first data received by the reception unit includes no specific information.

12. The image communication apparatus according to claim 1, wherein the specific information is transmission destination information of the second data.

13. A method for controlling an image communication apparatus, the method comprising:
receiving first data from an external device;
storing the received first data when the first data includes specific information;
reading a document image and creating document image data;
creating second data by adding the document image data to the first data;
determining a transmission destination of the second data based on the first data; and
transmitting the second data to the determined transmission destination.

14. The method according to claim 13, wherein the first data includes message data and first image data, and wherein the second data is created by adding the first image data and the document image data to the message data.

15. The method according to claim 14, further comprising combining the first image data and the document image data as combined data, wherein the second data is created by adding the combined data to the message data.

16. The method according to claim 13, wherein the first data and second data are electronic mail formatted data, wherein a transmission described in a predetermined portion in the first data is determined as a transmission destination of the second data, wherein an electronic mail including the second data is transmitted to the determined transmission destination.

17. The method according to claim 13, further comprising:
authenticating a user who uses the image communication apparatus;
displaying information relating to the first data;
receiving user operational instructions for selecting the first data;
storing the first data in relation to information identifying a transmission source user of the first data; and
displaying information indicating the first data when an authenticated user is a user stored in relation to the first data.

18. The method according to claim 13, wherein predetermined processing is performed for the first data when the first data received includes no specific information.

19. The method according to claim 13, wherein the specific information is transmission destination information of the second data.

20. A computer-readable storage medium storing computer-executable process steps enabling an image communication apparatus to execute an image communication method, the computer-executable process steps comprising:
receiving first data from an external device;
storing the first data when the first data includes specific information;
reading a document image and creating document image data;
creating second data by adding the document image data to the first data;
determining a transmission destination of the second data based on the first data; and
transmitting the second data to the determined transmission destination.
